(19) United States
(12) Patent Application Publication
(10) Pub. No.: US 2021/0163632 A1
(43) Pub. Date: Jun. 3, 2021

(54) RUBBER COMPOSITION

(71) Applicant: COMPAGNIE GENERALE DES ETABLISSEMENTS MICHELIN, Clermont-Ferrand (FR)

(72) Inventors: Anne-Frédérique SALIT, Clermont-Ferrand Cedex 9 (FR); Anne-Lise THUILLIEZ, Clermont-Ferrand Cedex 9 (FR); Céline LEDOUX, Clermont-Ferrand Cedex 9 (FR)

(73) Assignee: COMPAGNIE GENERALE DES ETABLISSEMENTS MICHELIN, Clermont-Ferrand (FR)

(21) Appl. No.: 16/771,013

(22) PCT Filed: Oct. 11, 2018
(86) PCT No.: PCT/FR2018/052520

§ 371 Date: Jun. 9, 2020

(30) Foreign Application Priority Data
Dec. 20, 2017 (FR) 1762563

(51) Int. Cl. C08C 19/22; C08C 19/34; B60C 1/00

(52) U.S. Cl. CPC C08C 19/22; B60C 2001/0066; B60C 1/0041; C08C 19/34

(57) ABSTRACT

A rubber composition based at least on a reinforcing filler comprising a carbon black and on a natural rubber is provided. The natural rubber is modified so that it carries pendent groups of formula (I) in which the symbols Y₁, Y₂, Y₃ and Y₄, which may be identical or different, represent an atom or a group of atoms. At least one of the symbols Y₁, Y₂, Y₃ and Y₄ denotes an attachment to an isoprene unit of the modified natural rubber. The carbon black represents more than 50% by weight of the reinforcing filler

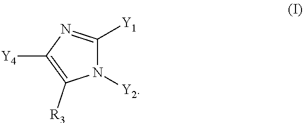

This application is a 371 national phase entry of PCT/FR2018/052520 filed on Oct. 11, 2018, which claims benefit of French Patent Application No. 1762563, filed 20 Dec. 2017, the entire contents of which are incorporated herein by reference for all purposes.

### BACKGROUND

### 1. Technical Field

The present invention relates to diene rubber compositions predominantly reinforced with carbon black which are intended to be used in particular in a tire.

### 2. Related Art

Natural rubber has the remarkable property of imparting good mechanical strength in the uncured state to a rubber composition mainly reinforced with carbon black. This property of mechanical strength in the uncured state, i.e. before crosslinking, is generally important in the operations for assembling multiple rubber components which are still in the uncured state, such as for example in the manufacture of a tire. A high mechanical strength in the uncured state of the constituent rubber compositions of the rubber components of the assembly makes it possible to guarantee the dimensional stability of the assembly, in particular by preventing the flow of the rubber components. A high mechanical strength in the uncured state of a rubber composition also makes it possible to maintain the thread gap in fabrics, rubber components comprising thread-like reinforcing elements, for example textile or metallic reinforcing elements, coated in the rubber composition. These remarkable properties explain why natural rubber still remains one of the major components of semi-finished articles for tires.

At the same time, it is noted that the demand for vehicles is increasing, which also results in an increase in demand for tires, while at the same time the demand for articles based on natural products continues to grow. Since natural rubber is a natural product with remarkable properties, it can be expected that the demand for natural rubber will also increase. The availability of natural rubber is linked to the capacity of Hevea plantations to produce natural rubber, which, as is known, may be limited by the age of the Hevea plants, by climatic hazards, geopolitical uncertainties and diseases that can affect the plants. It may be strategic to reduce the portion of natural rubber in semi-finished products for tires. One way to do this is to reduce the thickness of the rubber strips that make up the semi-finished articles. However, this reduction must be done while maintaining the mechanical strength performance in the uncured state of the rubber strip. It is therefore a preoccupation to even further improve the mechanical strength in the uncured state of rubber compositions mainly reinforced with carbon black and based on natural rubber, in order to be able to reduce the portion of natural rubber in semi-finished articles.

### SUMMARY

The Applicant has unexpectedly discovered a rubber composition mainly reinforced with carbon black and based on natural rubber which exhibits further improved mechanical strength in the uncured state.

Thus, a first subject of the invention is a rubber composition based at least on a reinforcing filler comprising a carbon black and on a natural rubber modified in that it carries pendent groups of formula (I) in which the symbols Y₁, Y₂, Y₃ and Y₄, which may be identical or different, represent an atom or a group of atoms knowing that at least one of the symbols denotes an attachment to an isoprene unit of the modified natural rubber, the carbon black representing more than 50% by weight of the reinforcing filler.

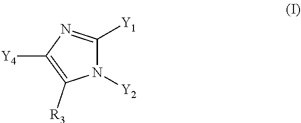

Another subject of the invention is a composite comprising a rubber composition in accordance with the invention and at least one reinforcing element coated in the rubber composition.

The invention also relates to a semi-finished article comprising reinforcing elements having a surface intended to come into contact with a rubber composition, which reinforcing elements are coated in the rubber composition, the rubber composition being in accordance with the invention.

The invention also relates to a tire comprising a rubber composition in accordance with the invention or a semi-finished article in accordance with the invention.

The invention also relates to a process for manufacturing a rubber composition in accordance with the invention.

### I. DETAILED DESCRIPTION

The abbreviation “phr” means parts by weight per hundred parts of elastomer (of the total of the elastomers, if several elastomers are present).

Furthermore, any interval of values denoted by the expression “between a and b” represents the range of values greater than “a” and less than “b” (that is to say, limits a and b excluded), whereas any interval of values denoted by the expression “from a to b” means the range of values extending from “a” up to “b” (that is to say, including the strict limits a and b).

The expression “composition based on” should be understood as meaning, in the present description, a composition comprising the mixture and/or the in situ reaction product of the various constituents used, some of these base constituents (for example the elastomer, the filler or other additive conventionally used in a rubber composition intended for the manufacture of tires) being capable of reacting or intended to react with one another, at least in part, during the various phases of manufacture of the composition intended for the manufacture of tires.

The compounds mentioned in the description can be of fossil origin or biobased. In the latter case, they may be partially or totally derived from biomass or may be obtained from renewable starting materials derived from biomass.

The essential characteristic of the rubber composition in accordance with the invention is that it comprises a modified natural rubber. Preferably, the modified natural rubber is different from an epoxidized natural rubber. The modified natural rubber is a natural rubber which has pendent groups of formula (I)

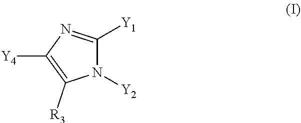

in which the symbols Y₁, Y₂, Y₃ and Y₄, which may be identical or different, represent an atom or a group of atoms, knowing that at least one of the symbols denotes an attachment to an isoprene unit of the modified natural rubber. Those skilled in the art understand that the functional groups are attached to the elastomer by covalent bonding. In the present application, a group of atoms is understood to mean a sequence of atoms covalently bonded to form a chain. According to any one of the embodiments of the invention, preferably a single symbol denotes an attachment to an isoprene unit of the modified natural rubber. The attachment is a direct or indirect attachment to an isoprene unit of the modified natural rubber. The attachment is preferably indirect, that is to say through a group of atoms. When neither Y₃, nor Y₄ denotes an attachment to an isoprene unit of the natural rubber, Y₃ and Y₄ may form, with the two carbon atoms to which they are attached, a ring, in particular an aromatic ring.

According to one preferred embodiment of the invention, the symbol Y₂ denotes the attachment to an isoprene unit of the modified natural rubber.

According to another preferred embodiment of the invention, the symbols Y₃ and Y₄ are each a hydrogen atom and the symbol Y₁ represents a hydrogen atom or a carbon chain which may contain at least one heteroatom. In the present application, a carbon chain is understood to mean a chain which contains one or more carbon atoms.

According to a very particularly preferred embodiment, the symbol Y₂ denotes the attachment to an isoprene unit of the modified natural rubber, the symbols Y₃ and Y₄ are each a hydrogen atom and the symbol Y₁ represents a hydrogen atom or a carbon chain which may contain at least one heteroatom.

Advantageously, Y₁ is a hydrogen atom or an alkyl group. When the symbol Y₁ represents an alkyl group, the alkyl group is preferentially a C₁-C₆ alkyl, more preferentially a methyl. A C₁-C₆ alkyl is understood to mean an alkyl which contains 1 to 6 carbon atoms.

According to any one of the embodiments of the invention, the pendent groups of formula (I) are preferably distributed randomly along the modified natural rubber chain.

The content of pendent groups of formula (I) in the modified natural rubber is preferentially at most 3 mol % of the constituent repeating units of the modified natural rubber. It varies preferentially within a range which extends from more than 0 mol % to 3 mol % of the constituent repeating units of the modified natural rubber, for example from 0.02 mol % to 3 mol % of the constituent repeating units of the modified natural rubber, more preferentially still from 0.1 mol % to 3 mol % of the constituent repeating units of the natural modified rubber. These preferential ranges may apply to any one of the embodiments of the invention.

According to one particularly preferred embodiment of the invention, the modified natural rubber is a natural rubber, a portion of the isoprene units of which are modified by grafting of a compound, compound C, which contains a group that is reactive with respect to carbon-carbon double bonds and a group of formula (II) in which the symbols Z₁, Z₂, Z₃ and Z₄, which may be identical or different, represent an atom or a group of atoms knowing that at least one of the symbols denotes an attachment to the reactive group. Preferably a single symbol denotes an attachment to the reactive group.

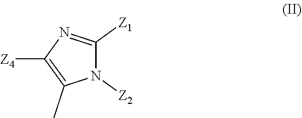

When neither Z₃, nor Z₄ denotes an attachment to the reactive group, Z₃ and Z₄ may form, with the two carbon atoms to which they are attached, a ring, in particular an aromatic ring.

In formula (II), the symbol Z₂ preferably denotes the attachment to the reactive group. Preferably, the symbols Z₃ and Z₄ each represent a hydrogen atom and the symbol Z₁ represents a hydrogen atom or a carbon chain which may contain at least one heteroatom, in particular an alkyl, more particularly an alkyl containing 1 to 6 carbon atoms, that is to say a C₁-C₆ alkyl. Advantageously, the alkyl group represented by Z₁ is a methyl.

In other words, the modified natural rubber is, according to this particularly preferred embodiment of the invention, obtained by modification of a natural rubber, known as the starting natural rubber, by a grafting reaction of the compound C. According to this particularly preferred embodiment of the invention, the modified natural rubber comprises both isoprene units and isoprene units modified by the grafting of the compound C.

Preferably, the compound C is a 1,3-dipolar compound. The term “1,3-dipolar compound” is understood according to the definition given by the IUPAC. It has the feature of comprising a single dipole and the group of formula (II). The dipole constitutes the reactive group of the compound C that is reactive with respect to carbon-carbon double bonds. The dipole typically reacts with the carbon-carbon double bonds of isoprene units. The bringing together of the starting natural rubber and of the compound C leads to the modification of part of the isoprene units of the starting natural rubber. The 1,3-dipolar compound of use for the requirements of the invention is preferably an aromatic nitrile monoxide. An aromatic nitrile monoxide compound is understood to mean an aromatic compound which contains a single nitrile oxide dipole and in which the benzene ring is substituted by the nitrile oxide dipole, which means that the carbon atom of the dipole is directly bonded via a covalent bond to a carbon atom of the benzene ring. Advantageously, the benzene ring is substituted in the position ortho to the dipole.

Advantageously, the 1,3-dipolar compound contains a moiety of formula (III) in which four of the six symbols R₁ to R₆, which may be identical or different, are each an atom or a group of atoms, knowing that the fifth symbol represents an attachment to the group of formula (II) and the sixth symbol a direct attachment to the dipole.

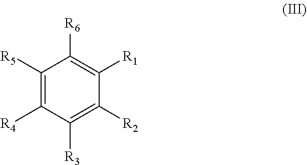

According to any one of the embodiments of the invention, the symbols R₁ and R₅ in the formula (III) are preferably both different from a hydrogen atom, which makes it possible to confer greater stability of the 1,3-dipolar compound and thus easier use of the 1,3-dipolar compound.

In formula (III), the symbols R₁, R₃ and R₅ each preferably represent a hydrocarbon-based group, more preferentially an alkyl group, more preferentially still a methyl or ethyl group.

According to any one of the embodiments of the invention, the symbols R₂ and R₄ in formula (III) are preferentially each a hydrogen atom.

In formula (III), the symbols R₁, R₃ and R₅ each preferably represent a hydrocarbon-based group, more preferentially an alkyl group, more preferentially still a methyl or ethyl group and the symbols R₂ and R₄ are each preferentially a hydrogen atom. With a benzene ring thus substituted, the synthesis of the 1,3-dipolar compound may then be carried out using a relatively easy synthesis route using a commercially available precursor, for example mesitylene, as is described for example in document WO 2015059269.

In formula (III), the fifth symbol is attached to the group of formula (II), preferably through a group of atoms referred to as a spacer. The spacer is preferably a carbon chain which may contain at least one heteroatom. The spacer preferably contains 1 to 6 carbon atoms, in particular 1 to 3 carbon atoms. The spacer is more preferentially an alkanediyl group, better still a methanediyl group.

According to any one of the embodiments of the invention, the 1,3-dipolar compound is advantageously the compound 2,4,6-trimethyl-3-((2-methyl-1H-imidazol-1-yl)methyl)benzonitrile oxide of formula (III-a) or the compound 2,4,6-triethyl-3-((2-methyl-1H-imidazol-1-yl)methyl)benzonitrile oxide of formula (III-b), more advantageously the compound of formula (III-a).

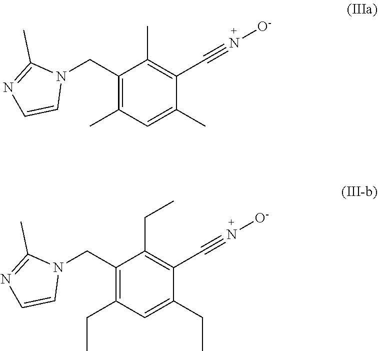

The rubber composition in accordance with the invention also has the essential characteristic of comprising a reinforcing filler. The reinforcing filler of use for the requirements of the invention comprises a carbon black, which carbon black represents more than 50% by weight of the reinforcing filler. All carbon blacks, in particular the blacks conventionally used in tires, in particular in the reinforcements such as the carcass reinforcements or the crown reinforcements, are suitable as carbon blacks. Mention may very particularly be made of the ASTM grades of the 300 to 700 series, or alternatively the HAF, FF, FEF, GPF and SRF grades.

Preferably, the carbon black represents more than 90% by weight of the reinforcing filler. The carbon black may also constitute all of the reinforcing filler for any one of the embodiments of the invention.

The content of carbon black in the rubber composition may vary to a large extent. It is adjusted depending on the use for which the rubber composition is intended, in particular in a tire. When the rubber composition is intended to form a reinforcement for a tire, the content of carbon black is preferentially within a range extending from 30 to 80 phr. A content below 30 phr may lead to a reinforcement of the rubber composition after crosslinking which may be judged to be insufficient for use in a composite which comprises at least one reinforcing element, for example in a reinforcement for a tire. A content above 80 phr may be accompanied by a degree of rigidity which may be considered to be too high for use in a reinforcement.

The rubber composition in accordance with the invention may also comprise all or some of the usual additives customarily used in the compositions. The rubber composition can in particular comprise an elastomer other than the modified natural rubber. In particular, this other elastomer can bean unmodified elastomer, for example the starting natural rubber used in the preparation of the modified natural rubber. The content of modified natural rubber in the rubber composition in accordance with the invention is preferentially at least 50 phr, more preferentially at least 75 phr, more preferentially still at least 90 phr. The content of modified natural rubber in the rubber composition therefore varies preferentially from 50 to 100 phr, more preferentially from 75 to 100 phr, more preferentially still from 90 to 100 phr. These preferential contents of modified natural rubber in the rubber composition may apply to any one of the embodiments of the invention.

The rubber composition may contain a modified natural rubber crosslinking system. The crosslinking system can be a vulcanization system or be based on one or more peroxide compounds, for example conventionally used in rubber compositions that can be used for the manufacture of tires. The crosslinking system is preferentially a vulcanization system, that is to say a system based on sulfur (or on a sulfur donor) and on a primary vulcanization accelerator. Added to this base vulcanization system are various known secondary vulcanization accelerators or vulcanization activators, such as zinc oxide, stearic acid or equivalent compounds, or guanidine derivatives (in particular diphenylguanidine), or also known vulcanization retarders, incorporated during the first non-productive phase and/or during the productive phase, such as described subsequently. The sulfur is used at a preferred content of between 0.5 and 12 phr, in particular between 1 and 10 phr. The primary vulcanization accelerator is used at a preferred content of between 0.5 and 10 phr.

When the rubber composition is intended to be used in a composite which comprises at least one metal reinforcing element, the rubber composition contains sulfur, preferentially at a content which may be greater than 2 phr and may reach up to 8.5 phr, preferably from 3.5 to 7 phr. In the rubber compositions intended to be bought into contact with at least one metal reinforcing element, the surface of which is brass-plated, a portion of the sulfur is consumed in the formation of a bonding interface between the rubber composition and the metal. Therefore, the sulfur is present in such rubber compositions intended for the preparation of composites or layers adjacent to these composites, in proportions greater than those customarily used in other compositions, for example for treads.

The rubber composition may also contain other additives known for being used in rubber compositions for tires, such as pigments, processing aids, antiozonants, antioxidants, systems for promoting adhesion with respect to metal, in particular brass-plated, reinforcers, such as for example metal salts such as organic cobalt or nickel salts. Those skilled in the art will know how to adjust the formulation of the composition depending on their specific requirements.

When the rubber composition is intended to be used in a composite which comprises at least one metal reinforcing element, the rubber composition may further comprise at least one adhesion promoter, preferably a cobalt compound. This cobalt compound is preferentially an organic cobalt compound, typically selected from cobalt carboxylates, compounds that are well known for being used as adhesion promoter. The content thereof in the rubber composition is preferentially between 0.1 and 10 phr, more preferentially between 0.3 and 6 phr, in particular between 0.5 and 4 phr.

The rubber composition in accordance with the invention is typically manufactured in appropriate mixers, using two successive phases of preparation well known to those skilled in the art: a first phase of thermomechanical working or kneading (“non-productive” phase) at high temperature, up to a maximum temperature of between 130° C. and 200° C., followed by a second phase of mechanical working (“productive” phase) up to a lower temperature, typically below 110° C., for example between 40° C. and 100° C., during which finishing phase the crosslinking system is incorporated.

The rubber composition, according to a particular embodiment of the invention, may be manufactured according to a process, another subject of the invention, which comprises the following steps:
during a “non-productive” first step, kneading the natural rubber and a compound C by thermomechanically kneading, the compound C being as defined above,
subsequently adding the reinforcing filler and, if appropriate, the other ingredients of the rubber composition, with the exception of the crosslinking system, by thermomechanically kneading until a maximum temperature of between 130° C. and 200° C. is reached,
cooling the combined mixture to a temperature of less than 100° C.,
subsequently incorporating the crosslinking system,
kneading everything up to a maximum temperature of less than 120° C.

The final composition thus obtained may then be calendered, for example in the form of a sheet or a slab, or else extruded, for example in order to form a rubber profiled element used for the manufacture of a composite or a semi-finished product, such as, for example, a reinforcement for a tire.

The rubber composition in accordance with the invention, which may be either in the uncured state (before crosslinking or vulcanization) or in the cured state (after crosslinking or vulcanization), can be used in a semi-finished article for a tire, which is another subject of the invention.

According to a particular embodiment of the invention, the rubber composition is used in a composite, which is another subject of the invention. The composite in accordance with the invention also has the essential feature of comprising at least one reinforcing element coated in the rubber composition defined according to any one of the embodiments of the invention. The composite may be manufactured by a process which comprises the following steps: producing two layers of the rubber composition, sandwiching each reinforcing element in the two layers by depositing it between the two layers, and if necessary crosslinking the modified natural rubber, in particular by vulcanization. The layers may be produced by calendering.

The reinforcing element, also referred to as a reinforcer, may be metal or textile. In the present application, “textile” is understood to mean, in a manner well known to those skilled in the art, any material made of a substance other than a metallic substance, whether natural or synthetic, which is capable of being transformed into thread, fibre or film by any appropriate transformation process. Mention may be made, for example, without the examples below being limiting, of a polymer spinning process, such as, for example, melt spinning, solution spinning or gel spinning. The textile reinforcer may be made of polymer material, of both thermoplastic and non-thermoplastic type, of natural or synthetic origin. Any textile reinforcer known for being able to be used in a reinforcement for a tire is suitable.

The reinforcer may be in various forms, preferably in the form of an individual thread (monofilament) or an assembly of threads, whether these threads are twisted together (for example, in the form of a cord) or are essentially parallel to one another. The reinforcer is more preferentially in the form of an individual thread or an assembly of threads, for example a cord or a strand manufactured with cabling or stranding devices and processes known to those skilled in the art, which are not described here for the simplicity of the description. The reinforcer may also be in the form of a ribbon or film, or also of a fabric produced from threads or fibres, for example a woven fabric with warp threads and weft threads, or else a twill fabric with cross threads. The term “thread” or “fibre” is generally understood to mean any elongate element of great length relative to its cross section, regardless of the shape, for example circular, oblong, rectangular, square, or even flat, of this cross section, it being possible for this thread to be straight or not straight, for example twisted or wavy. The largest dimension of its cross section is preferentially less than 5 mm, more preferentially less than 3 mm. The term “film” or “ribbon” is generally understood to mean an elongate element of great length relative to its cross section, the cross section of which has an aspect ratio (width to thickness) of greater than 5, preferably of greater than 10, and the width of which is preferentially at least equal to 3 mm, more preferentially at least equal to 5 mm.

When a metal reinforcer is used, use is preferably made of a reinforcer made of steel, in particular made of pearlitic (or ferritic-pearlitic) carbon steel, referred to in a known manner as “carbon steel”, or else made of stainless steel as described for example in patent application EP-A-648 891 or WO98/41682. However, it is of course possible to use other steels or other alloys. When the steel is a carbon steel, its carbon content is preferably between 0.01% and 1.2% or between 0.05% and 1.2%, or else between 0.2% and 1.2%, notably between 0.4% and 1.1%. When the steel is stainless, it preferably includes at least 11% of chromium and at least 50% of iron.

When the composites of the invention are used to reinforce carcass or crown reinforcements of radial tires, the reinforcers used are preferably assemblies (strands or cords) of thin carbon steel or stainless steel threads having:
a tensile strength greater than 2000 MPa, more preferentially greater than 2500 MPa, in particular greater than 3000 MPa; those skilled in the art know how to manufacture fine threads having such a strength, by adjusting in particular the composition of the steel and the final work-hardening contents of these threads;
for a good strength/bending strength/feasibility compromise, a diameter of between 0.10 and 0.40 mm, more preferentially between approximately 0.10 and 0.30 mm when the composite is intended to reinforce a carcass reinforcement, between approximately 0.20 and 0.40 mm when the composite is intended to reinforce a crown reinforcement.

The composite may be used in a semi-finished article such as a reinforcement for a tire.

According to one embodiment of the invention, the semi-finished article is a reinforcement for a tire. The reinforcement for a tire is preferably a carcass reinforcement or a crown reinforcement.

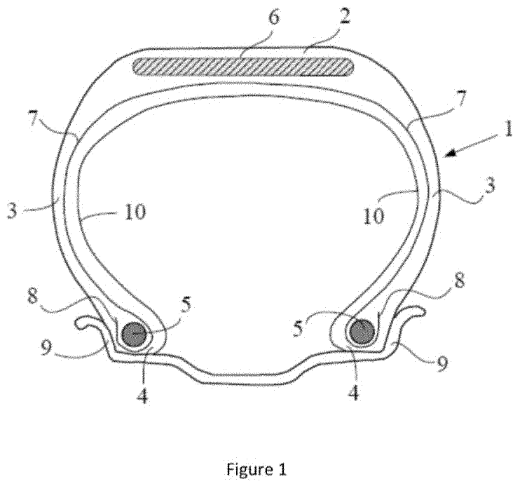

By way of example, FIG. 1 schematically depicts a radial section of a tire 1 with a radial carcass reinforcement in accordance with the invention. The tire 1 comprises a crown 2, two sidewalls 3, two beads 4, a carcass reinforcement 7 extending from one bead to the other. The crown 2, surmounted by a tread (not represented in this schematic figure, for simplification) is, in a manner known per se, reinforced by a crown reinforcement 6 consisting for example of at least two superposed crossed crown plies (“working” crown plies). The carcass reinforcement 7 is wound around the two bead wires 5 in each bead 4, the turn-up 8 of this reinforcement 7 being, for example, positioned towards the outside of the tire 1, which is represented here fitted onto its wheel rim 9. The carcass reinforcement 7 consists of at least one ply reinforced by “radial” cords, that is to say that these cords are positioned virtually parallel to one another and extend from one bead to the other so as to form an angle of between 80° and 90° with the median circumferential plane (plane perpendicular to the axis of rotation of the tire which is located halfway between the two beads 4 and passes through the middle of the crown reinforcement 6). Of course, this tire 1 also comprises, in a known manner, a layer of rubber or elastomer 10 commonly referred to as an inner lining or airtight layer, which defines the radially inner face of the tire and which is intended to protect the carcass ply from the diffusion of air originating from the space inside the tire. Advantageously, in particular in the case of a tire for a heavy-duty vehicle, it may further comprise a reinforcing intermediate elastomer layer (not represented in the figure) which is located between the carcass ply and the airtight layer.

The invention relates to the rubber composition, the composite, the semi-finished article and the tire in the uncured state (before crosslinking of the elastomer) or cured state (after crosslinking of the elastomer). Generally, during the manufacture of the tire, the composite or the semi-finished article is deposited in the uncured state (i.e. before crosslinking of the elastomer) in the structure of the tire before the step of curing the tire. The semi-finished article in accordance with the invention is preferably a reinforcement for a tire, in particular a carcass reinforcement or a crown reinforcement.

The abovementioned characteristics of the present invention, and also others, will be better understood on reading the following description of several exemplary embodiments of the invention, given by way of illustration and without implied limitation, said description being made in connection with the appended drawings, among which:

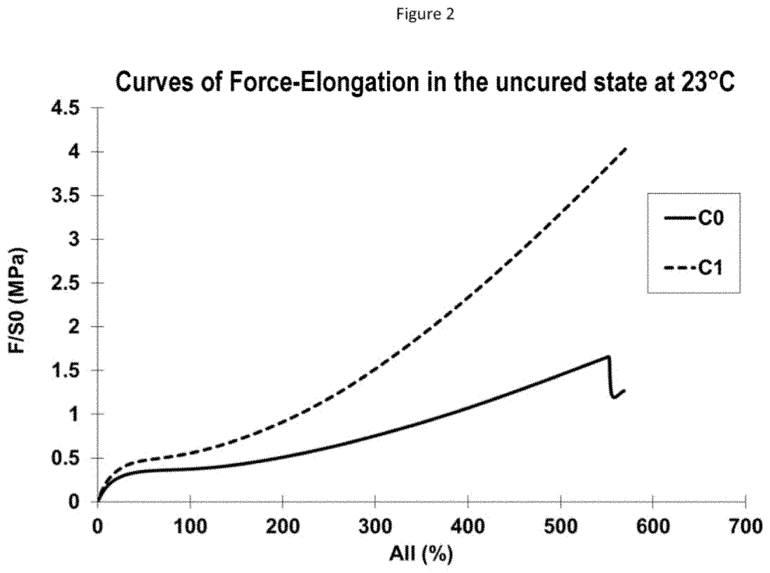

FIG. 2 is a graph of the apparent stress curves F/S₀ (MPa) as a function of the deformation (%) relating to non-crosslinked test specimens (uncured force-elongation curve or uncured FEC) which were obtained according to the method described in section 11.1 and which respectively consist of:
rubber composition of the state of the art (C0) comprising an unmodified natural rubber,
rubber composition in accordance with the invention (C1) comprising a natural rubber modified in that it carries pendent groups of formula (I).

### II. EXAMPLES OF IMPLEMENTATION

### II.1-Measurement and Test Used: Obtention of the Force-Elongation Curves of Non-Crosslinked Test Specimens:

1) Preparation of Slabs Consisting of Non-Crosslinked Rubber Compositions:

The composition passes through a calender, the rolls of which are at 75° C. so as to be in the form of a 2.9 mm thick sheet. This sheet is moulded under pressure in a mould for 10 minutes at 110° C. between two polyester sheets, then extracted from the mould and finally cooled in the open air. A 2.5 mm thick slab is thus obtained.

2) Conditioning of the Slabs Obtained:

Between the time of their preparation and that of the tensile test, each slab is stored in an ambient atmosphere for a duration at least equal to 5 hours and that cannot exceed 8 days.

3) Preparation of Test Specimens from these Slabs:

Each test specimen is then immediately cut in the shape of a dumbbell from one of the slabs thus extracted from the mould, so that it has two ends connected to one another by a rod of thickness E=2.5 mm, of length L=26 mm and of width W=6 mm. The cutting is carried out in such a way that the longitudinal direction L of the test specimen is parallel to the calendering direction.

4) Tensile Tests:

At least three identical test specimens are tested under the same conditions for each of the tensile tests performed.

Each tensile test consists in pulling each test specimen at a constant speed and in recording the change in the tensile force as a function of the displacement of a moving jaw of an INSTRON 4501 tensile machine. This machine is equipped with a force sensor and a means for measuring the displacement of this moving jaw. Each test specimen is held in its broadest part under a clamping pressure P equal to 2 bar.

Each tensile test is carried out at ambient temperature, in an air-conditioned laboratory at 23° C. (±2° C.) and at 50% (±10%) humidity. The constant speed of displacement of the moving jaw is 100 mm/minute. The variations in the tensile force and the displacement of the moving jaw are recorded during each test.

For each test specimen, the following parameters are calculated:
relative deformation α (%)=100×D/L (D being the displacement of the moving jaw in mm), measured by the sensor of the machine during each test, and L=26 mm is the initial length of the test specimen imposed by “the punch”), and
apparent stress F/S₀ (MPa), which represents the ratio of the force F (in N), measured by the sensor of the machine, to the initial cross section S₀ of the test specimen (S₀=W.E in mm², W=6 mm being the width imposed by “the punch” and E=2.5 mm being the thickness of the test specimen before pulling).

For each degree of relative deformation, the average of the corresponding stresses was calculated for three identical test specimens, and thus a stress (average of three measurements)-deformation graph was plotted for each of the test specimens tested.

5) Determination of the Function Content of the Elastomers by Nuclear Magnetic Resonance (NMR):

The molar content of grafted nitrile oxide compound is determined by an NMR analysis. The samples are dissolved in deuterated chloroform (CDCl₃) with the aim of obtaining a “lock” signal. The calibration for the ¹H NMR experiment is carried out on the signal at 7.20 ppm when CDCl₃ is the solvent used. The spectra are acquired on a 500 MHz Bruker spectrometer equipped with a “5 mm BBFO Z-grad CryoProbe”. The quantitative ¹H NMR experiment uses a simple 300 pulse sequence and a repetition time of 5 seconds between each acquisition. 2D NMR experiments made it possible to confirm the nature of the grafted unit by virtue of the chemical shifts of the carbon and proton atoms.

### II.2-Preparation of the Rubber Compositions:

Two rubber compositions C0 and C1 are prepared. Their formulation is given in Table 1.

For the preparation of the composition C0, the procedure is as follows: the natural rubber is introduced into an internal mixer (final degree of filling: approximately 70% by volume), the initial tank temperature of which is approximately 110° C., followed by the reinforcing filler, and also the various other ingredients with the exception of the vulcanization system. Thermomechanical working (non-productive phase) is then carried out in one step, which lasts approximately 5 min to 6 min, until a maximum “dropping” temperature of 160° C. is reached. The mixture thus obtained is recovered and cooled and then sulfur and an accelerator of sulfenamide type are incorporated on a mixer (homofinisher) at 23° C., everything being mixed (productive phase) for an appropriate time (for example between 5 and 12 min).

The compositions thus obtained are subsequently calendered, either in the form of slabs (with a thickness ranging from 2 to 3 mm) or thin sheets of rubber, for the measurement of their physical or mechanical properties, or to be used as reinforcement for a tire.

For the composition C1, the procedure is the same as for the composition C0 except that, before introducing the reinforcing filler, the 1,3-dipolar compound is introduced and is kneaded alone with (unmodified) natural rubber for 1 to 2 minutes at 110° C., which makes it possible to modify the natural rubber with pendent groups of formula (I) before introducing the other ingredients of the rubber composition. The content of 1,3-dipolar compound introduced into the internal mixer in order to functionalize the natural rubber before introducing the other ingredients of the rubber composition appears in Table 1 and is expressed in phr. The content introduced corresponds to a molar degree of modification of 0.6 mol % per 100 mol of the constituent repeating units of the modified natural rubber.

The rubber composition C0 is a reference rubber composition, conventionally used in a reinforcement for a tire, the elastomer being natural rubber.

The rubber composition C1 is a rubber composition in accordance with the invention, since it contains a natural rubber modified in that it carries pendent groups of formula (I) and a reinforcing filler comprising more than 50% by weight of a carbon black. The modified natural rubber is synthesized by the reaction of a natural rubber and of a 1,3-dipolar compound, 2,4,6-trimethyl-3-((2-methyl-1H-imidazol-1-yl)methyl)benzonitrile oxide of formula (III-a).

### II.3-Results:

The values of the deformations and the stresses at break of the compositions are summarized in Table 2.

FIG. 2 and Table 2 show that the rubber composition C1 in accordance with the invention has a much higher apparent stress F/S₀ than the reference rubber composition C0. The introduction of pendent groups of formula (I) on the natural rubber makes it possible to very significantly improve the properties of mechanical strength in the uncured state of the rubber composition mainly reinforced with carbon black and based on natural rubber. This strong improvement in the mechanical strength in the uncured state makes it possible to envisage reducing the thickness of one or more constituent layers of an assembly, in particular in the manufacture of a semi-finished product while guaranteeing the dimensional stability of the assembly and maintaining the gap of the threads in the fabrics. The use of a rubber composition in accordance with the invention in a reinforcement for a tire such as a carcass or crown reinforcement therefore proves to be particularly advantageous.

TABLE 1

| | Not in accordance with | In accordance with |
|---|---|---|
| Compositions in phr | the invention C0 | the invention C1 |
| NR (1) | 100 | 100 |
| Carbon black | 65 | 65 |
| 6PPD (2) | 2.0 | 2.0 |
| Cobalt salts | 2.0 | 2.0 |
| Stearic acid (3) | 0.6 | 0.6 |
| ZnO (4) | 8.0 | 8.0 |
| Sulfur | 6 | 6 |
| TBBS (5) | 1 | 1 |
| Compound III-a | — | 1.13 |

1): Natural rubber; (2): N-1,3-dimethylbutyl-N-phenyl-para-phenyldiamine (“Santoflex 6-PPD” from Flexsys); (3): Stearin “Pristerene 4931” from Uniquema; (4): Zinc oxide, industrial grade—Umicore; (5): N-(tert-butyl)-2-benzothiazolesulfenamide (Santocure TBBS from Flexsys).

TABLE 2

Compositions

| Uncured properties 23° C. | C01 | C02 |
|---|---|---|
| Deformation | 617 | 681 |
| at break (%) | | |
| Apparent stress | 1.90 | 5.21 |
| at break (MPa) | | |

1. A rubber composition based at least on a reinforcing filler comprising a carbon black and on a natural rubber, the natural rubber being modified so that it carries pendent groups of formula (I) in which the symbols Y₁, Y₂, Y₃ and Y₄, which may be identical or different, represent an atom or a group of atoms, at least one of the symbols Y₁, Y₂, Y₃ and Y₄ denotes an attachment to an isoprene unit of the modified natural rubber, and the carbon black representing more than 50% by weight of the reinforcing filler

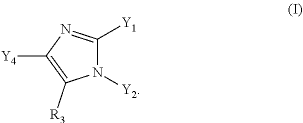

2. The rubber composition according to claim 1, in which the content of pendent groups of formula (I) in the modified natural rubber is at most 3 mol % of the constituent repeating units of the modified natural rubber.

3. The rubber composition according to claim 1, in which Y₂ denotes the attachment to an isoprene unit of the modified natural rubber.

4. The rubber composition according to claim 1, in which Y₃ and Y₄ are each a hydrogen atom and Y₁ represents a hydrogen atom or a carbon chain which may contain at least one heteroatom.

5. The rubber composition according to claim 1, in which Y₁ is a hydrogen atom or an alkyl group.

6. (canceled)

7. (canceled)

8. The rubber composition according to claim 1, in which the modified natural rubber is a natural rubber, a portion of the isoprene units of which are modified by grafting of a compound which contains a group that is reactive with respect to carbon-carbon double bonds and a group of formula (II) 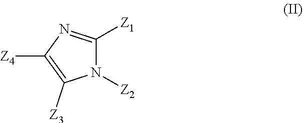
in which the symbols Z₁, Z₂, Z₃ and Z₄, which may be identical or different, represent an atom or a group of atoms, and at least one of the symbols denotes an attachment to the reactive group.

9. The rubber composition according to claim 8, in which Z₂ denotes the attachment to the reactive group, Z₃ and Z₄ are each a hydrogen atom, and Z₁ is a hydrogen atom or an alkyl group.

10. (canceled)

11. (canceled)

12. (canceled)

13. (canceled)

14. The rubber composition according to claim 8, in which the compound C is a 1,3-dipolar compound, which compound contains a single dipole as reactive group and the group of formula (II).

15. The rubber composition according to claim 14, in which the 1,3-dipolar compound is an aromatic nitrile monooxide, a compound comprising a benzene ring substituted by a nitrile oxide dipole.

16. (canceled)

17. The rubber composition according to claim 14, in which the 1,3-dipolar compound contains a moiety of formula (III) 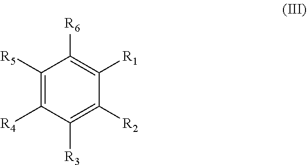
in which four of the six symbols R₁ to R₆, which may be identical or different, are each an atom or a group of atoms, and the fifth symbol represents an attachment to the group of formula (II) and the sixth symbol an attachment to the dipole.

18. (canceled)

19. The rubber composition according to claim 1, in which the modified natural rubber is different from an epoxidized natural rubber.

20. (canceled)

21. The rubber composition according to claim 1, in which the carbon black represents from 30 to 80 phr.

22. (canceled)

23. A composite comprising a rubber composition defined in claim 1 and at least one reinforcing element coated in the rubber composition.

24. A semi-finished article comprising reinforcing elements having a surface intended to come into contact with a rubber composition, which reinforcing elements are coated in the rubber composition, the rubber composition being defined in claim 1, and wherein the semi-finished article is a reinforcement for tires.

25. (canceled)

26. A tire comprising a rubber composition defined in claim 1.

27. (canceled)
